(19) United States
(12) Patent Application Publication
(10) Pub. No.: US 2026/0102905 A1
(43) Pub. Date: Apr. 16, 2026

(54) SYSTEMS AND METHODS FOR MAINTAINING OBJECT FLOW IN TRAILER UNLOADING SYSTEMS

(71) Applicant: Berkshire Grey Operating Company, Inc., Bedford, MA (US)

(72) Inventors: Joshua BEST, Raleigh, NC (US); Christopher GEYER, Arlington, MA (US); Joseph Corey MICHAL, Beverly, MA (US); Ananya TANDON, Belmont, MA (US); Jacob TORREY, Tyngsboro, MA (US)

(21) Appl. No.: 19/340,304

(22) Filed: Sep. 25, 2025

Related U.S. Application Data
(60) Provisional application No. 63/698,771, filed on Sep. 25, 2024.

(51) Int. Cl. B25J 9/00; B25J 9/16; B65G 43/08; B65G 67/24

(52) U.S. Cl. CPC B25J 9/0093; B65G 43/08; B65G 67/24; B25J 9/1697

(57) ABSTRACT

An object processing system for removing objects from a trailer of a tractor trailer includes a collection conveyance system for moving objects from within the trailer and providing the objects to an output conveyor of the collection conveyor system that leads to an object processing facility, a perception system for providing perception data regarding at least a portion of the collection conveyance system, a processing system for identifying whether the collection conveyance system is experiencing traffic with regard to passage of objects along the collection conveyance system, and a traffic remediation system for determining an action for an end-effector to take to remedy the traffic with regard to passage of objects along the collection conveyance system.

### PRIORITY

The present application claims priority to U.S. Provisional Patent Application 63/698,771 filed Sep. 25, 2024, the disclosure of which is hereby incorporated by reference in its entirety.

### BACKGROUND

The invention generally relates to automated, robotic and other object processing systems such as sortation systems, and relates in particular to automated and robotic systems intended for use in environments requiring, for example, that a variety of objects (e.g., parcels, packages, and articles, etc.) be processed and distributed to several output destinations.

Many parcel distribution systems receive parcels from a vehicle, such as a trailer of a tractor trailer. The parcels are unloaded and delivered to a processing station in a disorganized stream that may be provided as individual parcels or parcels aggregated in groups such as in bags, and may be provided to any of several different conveyances, such as a conveyor, or one or more pallets, Gaylords, or bins. Each parcel must then be distributed to the correct destination container, as determined by identification information associated with the parcel, which is commonly determined by a label printed on the parcel or on a sticker applied to the parcel. The destination container may take many forms, such as a bag or a bin.

The sortation of such parcels from the vehicle has traditionally been done, at least in part, by human workers that unload the vehicle, then scan the parcels, e.g., with a hand-held barcode scanner, and then place the parcels at assigned locations. For example, many order fulfillment operations achieve high efficiency by employing a process called wave picking. In wave picking, orders are picked from warehouse shelves and placed at locations (e.g., into bins) containing multiple orders that are sorted downstream. At the sorting stage individual articles are identified, and multi-article orders are consolidated, for example into a single bin or shelf location, so that they may be packed and then shipped to customers. The process of sorting these objects has traditionally been done by hand. A human sorter picks an object from an incoming bin, finds a barcode on the object, scans the barcode with a handheld barcode scanner, determines from the scanned barcode the appropriate bin or shelf location for the object, and then places the object in the so-determined bin or shelf location where all objects for that order have been defined to belong. Automated systems for order fulfillment have also been proposed, but such systems still require that objects be first removed from a vehicle for processing if they arrive by vehicle.

Such systems do not therefore, adequately account for the overall process in which objects are first delivered to and provided at a processing station by a vehicle such as a trailer of a tractor trailer. Unloading trailers by human personnel, e.g., into Gaylords or large bins, takes considerable time. Additionally, many processing stations at which the Gaylords or large bins are received are at times, at or near full capacity in terms of available floor space and sortation resources. There is a further need therefore for systems to unload vehicles and efficiently and effectively provide a more ordered flow of objects for processing.

### SUMMARY

In accordance with an aspect, the invention provides an object processing system for removing objects from a trailer of a tractor trailer. The object processing system includes a collection conveyance system for moving objects from within the trailer and providing the objects to an output conveyor of the collection conveyor system that leads to an object processing facility, a perception system for providing perception data regarding at least a portion of the collection conveyance system, a processing system for identifying whether the collection conveyance system is experiencing traffic with regard to passage of objects along the collection conveyance system, and a traffic remediation system for determining an action for an end-effector to take to remedy the traffic with regard to passage of objects along the collection conveyance system.

In accordance with another aspect, the object processing system includes a collection conveyance system for moving objects from within the trailer and providing the objects to an output conveyor that leads to an object processing facility, a perception system for providing perception data regarding at least a portion of the collection conveyance system, a processing system for identifying whether movement of objects on the collection conveyance system are slowing with regard to passage of objects along the collection conveyance system, and a traffic avoidance system for determining an action to take to avoid traffic from developing with regard to passage of objects along the collection conveyance system.

In accordance with a further aspect, the invention provides a method of processing objects that includes moving objects from within the trailer of a tractor trailer along a collection conveyance system and providing the objects to an output conveyor that leads to an object processing facility, providing perception data regarding at least a portion of the collection conveyance system using a perception system, identifying whether the collection conveyance system is experiencing traffic regarding the passage of objects along the collection conveyance system using a processing system, determining an action for any of an end-effector or a single conveyor section of the collection conveyor system to take to remedy the traffic regarding the of passage of objects along the collection conveyance system, and executing the determined action for any of the end-effector or the single conveyor section of the collection conveyor system to take to remedy the traffic regarding the of passage of objects along the collection conveyance system.

### BRIEF DESCRIPTION OF THE DRAWINGS

The following description may be further understood with reference to the accompanying drawings in which:

FIG. 1 shows an illustrative diagrammatic view of an object processing system in accordance with an aspect of the present invention;

FIG. 2 shows an illustrative diagrammatic view of the loading section of the object processing system of FIG. 1;

FIG. 3 shows an illustrative diagrammatic enlarged view of the loading section of the object processing system of FIG. 1 showing the loading sensors and a collection sensor;

FIG. 4 shows an illustrative diagrammatic side view of the object processing system of FIG. 1 showing the loading sensors, a collection sensor, the pre-centering sensors, the centering sensors and some of the output sensors;

FIG. 5 shows a rear view of the object processing system of FIG. 1 showing the pre-centering sensors, the centering sensors, and some of the output sensors;

FIG. 6 shows an illustrative diagrammatic end view the loading section shown in FIG. 2;

FIGS. 7A and 7B show illustrative diagrammatic views of conveyors being used to facilitate clearing object traffic by moving in the same direction that is opposite the processing direction (FIG. 7A) and by having only one conveyor move in the processing direction (FIG. 7B);

FIG. 8 shows an illustrative diagrammatic view of conveyors being used to facilitate clearing object traffic by having only one conveyor move in the direction that is opposite the processing direction;

FIG. 9 shows an illustrative diagrammatic view of side conveyors being used to facilitate clearing object traffic by having each of the side conveyors move in directions that are respectively opposite the side processing directions;

FIGS. 10A and 10B show illustrative diagrammatic enlarged views of the loading portion of FIG. 2, showing a general show-down of object traffic (FIG. 10A) and showing an object being lifted to facilitate clearing object traffic (FIG. 10B);

FIG. 11 shows an illustrative diagrammatic view of two objects being lifted to facilitate clearing object traffic;

FIG. 12 shows an illustrative diagrammatic view of an object being pushed in a direction that is opposite the processing direction to facilitate clearing object traffic;

FIG. 13 shows an illustrative diagrammatic view of an object being pushed in a direction that is opposite the processing direction while two conveyors are moved in the processing direction to facilitate clearing object traffic;

FIG. 14 shows an illustrative diagrammatic view of an object being pushed in a direction that is opposite the processing direction while another object is pushed in the processing direction to facilitate clearing object traffic;

FIGS. 15A and 15B show portions of an illustrative diagrammatic flow chart for the object processing system of FIG. 1; and

FIG. 16 shows an illustrative diagrammatic functional diagram of a machine learning control system for use in the object processing system of FIG. 1.

The drawings are shown for illustrative purposes only.

### DETAILED DESCRIPTION

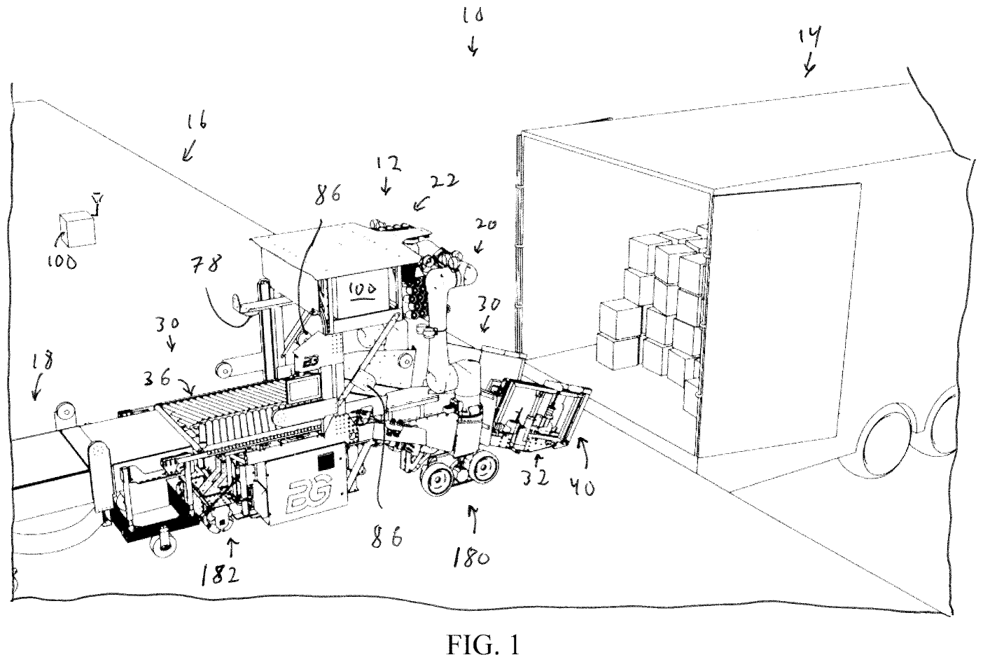

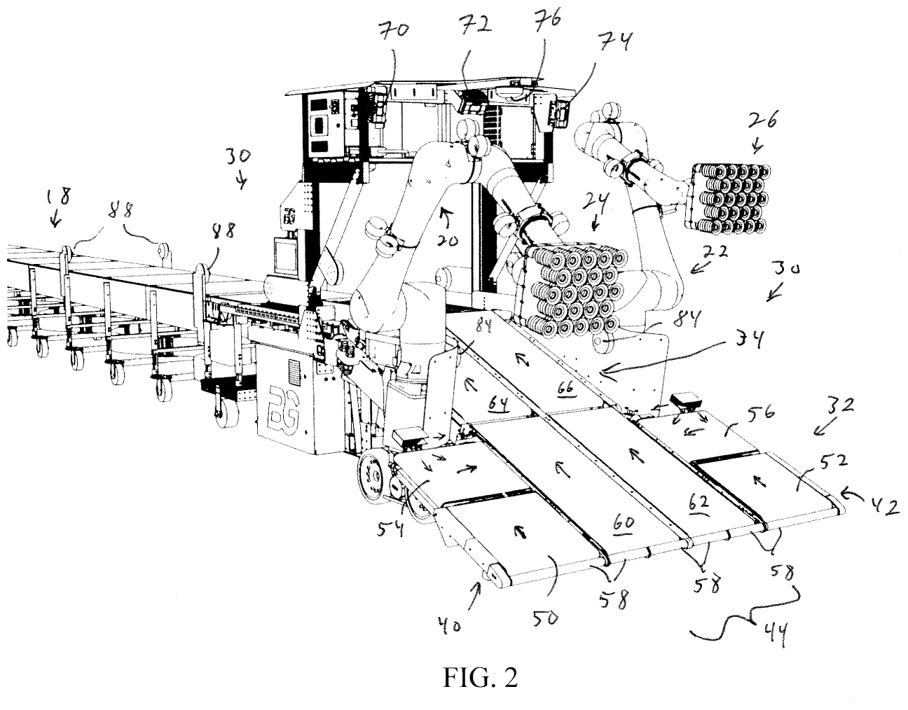

In accordance with various aspects and with reference to FIG. 1, the invention provides an object processing system 10 that includes a mobile system 12 that processes a collection of objects within a trailer 14 of a tractor trailer on a loading dock 16 and provides the objects via an output conveyor 18 to a facility for receiving the objects. The mobile system 12 includes a pair of programmable motion devices 20, 22, each with an end-effector 24, 26 (shown in FIG. 2) for urging objects onto a conveyor system 30 that includes a loading section 32, a collecting section 34, a centering section 36 and the output conveyor 18 as further shown in FIG. 2.

FIG. 2 shows that the loading section 32 of the collection conveyor system 30 includes outer wing hinged conveyor portions 40, 42 that each may be rotated with respect to a central region 44 of the loading section 32. FIG. 1 shows the outer wing hinged portion 40, 42 rotated upward such that they are generally vertical, and FIG. 2 shows the outer wing hinged portions 40, 42 rotated downward such that they are generally horizontal. Each outer wing hinged portion 40, 42 includes a loading direction conveyor 50, 52 respectively, and a cross-loading direction conveyor 54, 56 that each move objects thereon toward a center of the loading portion 32 of the collection conveyor system 30.

FIG. 3 shows the loading sensor array assembly 80, 82 of the object processing system of FIG. 1. Each loading sensor array assembly 80, 82 includes three sets of sensor arrays 81, 83, 85 that are directed in two mutually orthogonal directions (81, 85) and a third direction (83) intermediate the other two. The sensor array assemblies are positioned just above the conveyor sections 50, 52 54, 56, 60, 62 and provide sensor data regarding the presence of objects on the conveyor sections 50, 52 54, 56, 60, 62 and data regarding whether the objects are moving. The positioning of these sensors provides accurate information regarding the surface of the conveyor section 32 and are not occluded by the programmable motion devices (as the perception units 70, 72, 74 may be). The sensor array assemblies 80, 82 provide information regarding object presence on the conveyor section 32 as well as whether objects are moving on the conveyor section 32 relative the motion of the conveyor section 32 and the rate of any object motion. The sensor array assemblies 80, 82 further provide data regarding the density of coverage of the conveyor section 32. If for example, the density of coverage is high, the system may slow down new object collection. The sensors in the loading sensor arrays assemblies 80, 82 may, for example, the infrared distance sensors such as IR LEDs.

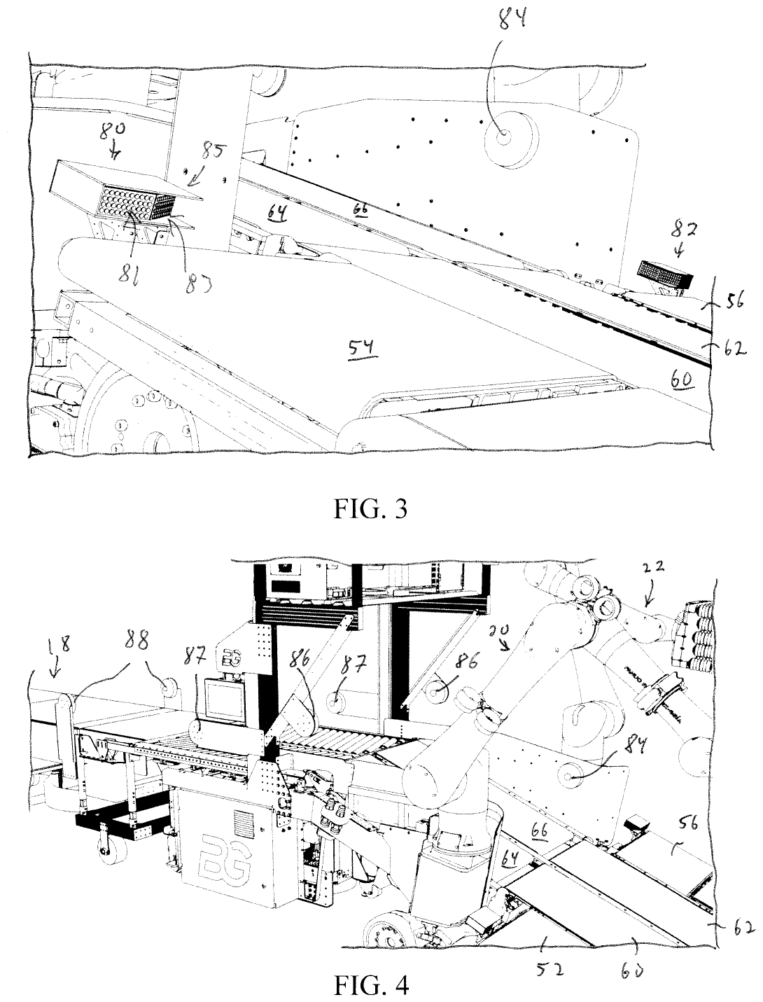

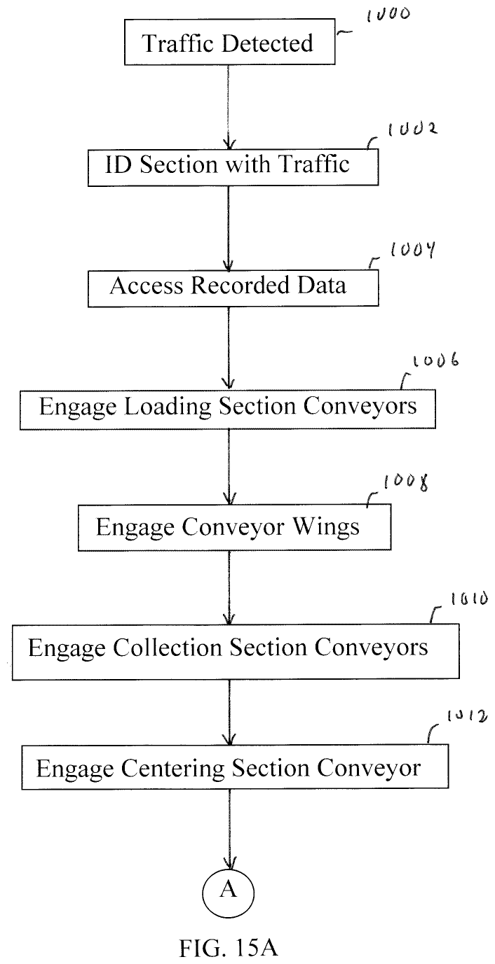

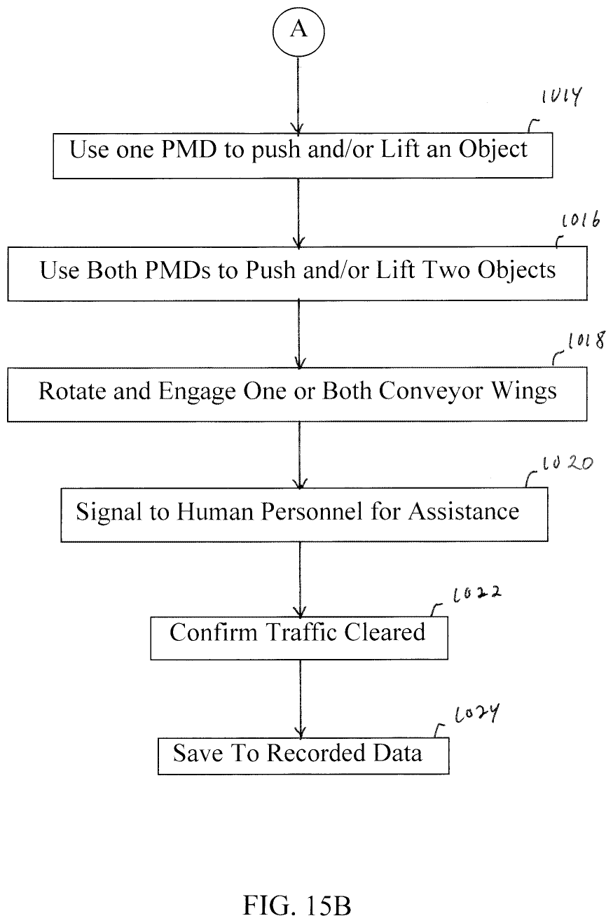

As further shown in FIG. 4 shows the system may also include a pair of collection sensors 84 that are directed above the collection conveyor sections 64, 66 to detect the presence of any tall objects on the collection conveyor sections 64, 66. The collection sensors 84 also provide information regarding the volume of objects on the collection sections 64, 66. The positioning of these sensors 84 (e.g., time-of-flight sensors) provides accurate information regarding the area above the conveyor sections 64, 66 and are not occluded by the programmable motion devices (as the perception units 70, 72, 74 may be). The conveyor sections may be engaged to topple any such tall objects, and the presence of such tall objects may require that actions be taken to reduce the probability of the tall objects causing traffic as discussed below with reference to FIGS. 15A and 15B. FIG. 4 further shows that the system may also include a pair of pre-centering sensors 86 as well as a pair of centering section sensors 87 that facilitate predicting potential traffic conditions so that actions may be taken to reduce the possibility of traffic as discussed further below with reference to FIGS. 15A and 15B. As also shown in FIG. 4, the output conveyor 18 may also include one, two or more sets of output sensors 88 for confirming that a (preferably) singulated stream of objects is being provided along the output conveyor 18. The sensors 86, 87, 88 may be distance sensors that provide a contrast value as well as distance value. And contrast value may provide an indication of whether the object is moving (changing contrast with steady state distance).

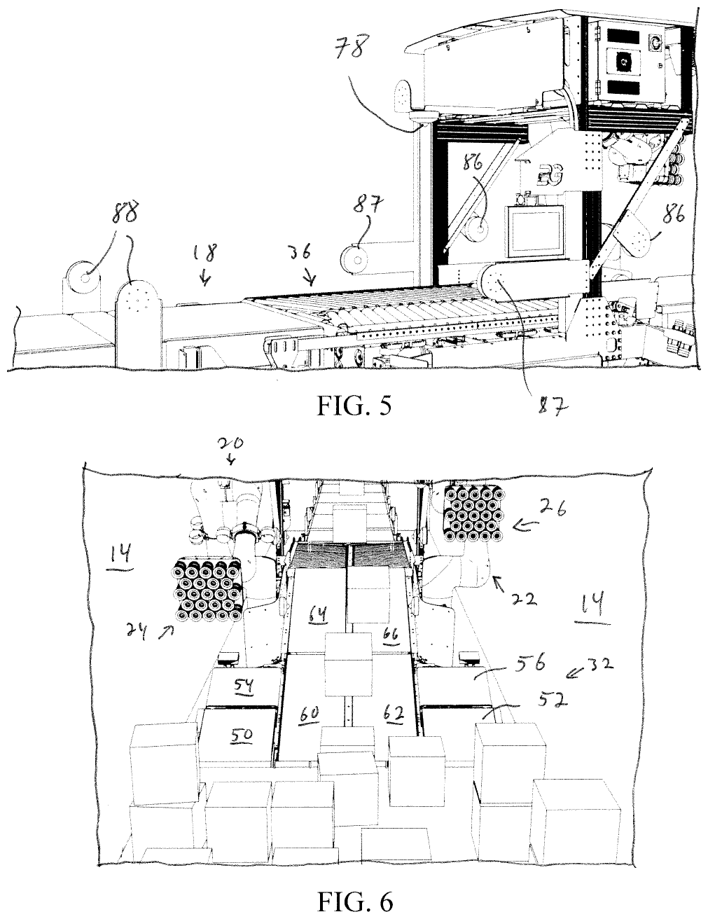

Navigation of the system, both entering and within a trailer, is facilitated by navigation sensors such as LIDAR or time-of-flight sensors 76 (shown in FIG. 2) and 78 as shown in FIG. 5. FIG. 5 also shows the centering section sensors 87 above the centering section 36 and a set of output sensors 88 above the output conveyor 18.

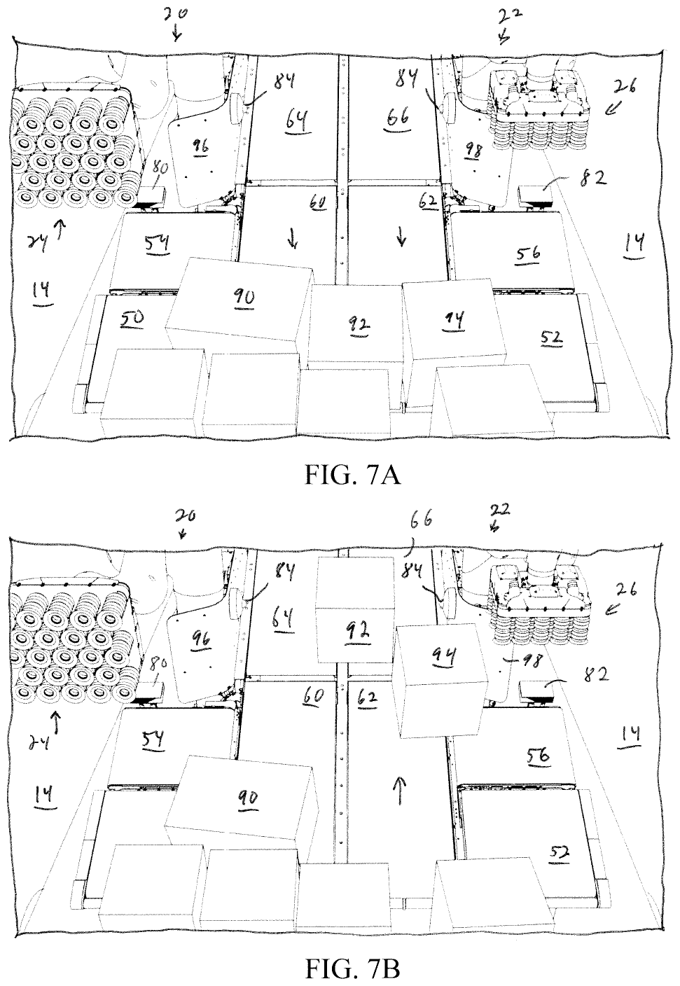

With reference to FIG. 6, objects are loaded onto the loading section 32 of the collection conveyor system (either by being placed onto the loading section 32 by an end-effector 24, 26) or by being kicked up onto the loading section 32 through the movement of the mobile system 12 and/or one or more kicker rollers 58 at the leading edge of the loading portion 32 (as shown in FIG. 2). The mobile system 12 is coupled to the output conveyor 18 for providing the objects to the facility as the mobile system 12 and output conveyor 18 are moved into the trailer 14. The mobile system 12 (together with the programmable motion device and the output conveyor 18 drawn behind it) may be moved into and out of the trailer 14 using one or more mobile unit motors. As the mobile system 12 is moved into the trailer, perception systems 70, 72, 74 (shown in FIG. 2) provide perception information (e.g., depth perception data, 2D or 3D scan data and/or camera image data) to assist in guiding the mobile system 12 into the trailer and in detecting a blockage, or jams or slow-downs (traffic) on the collection conveyor system 30 as discussed herein with reference to FIG. 7A-FIG. 14.

In accordance with certain aspects, the system may include a plurality of programmable motion devices and one or more kicker rollers as noted above with reference to FIG. 2. For example, FIG. 2 shows the mobile system 12 including two programmable motion devices 20, 22 as well as one or more computer processing systems (such as computer processing system 100 shown in FIG. 1) and one or more high flow vacuum sources for providing vacuum (in one or more zones) to each end-effector 24, 26. Both programmable motion devices 20, 22 may include the same type of end-effector (including, for example, an array of vacuum cups) or may include different types of end-effectors. Each of the programmable motion devices 20, 22 may move their respective end-effector about the space within the trailer to reach objects within the trailer and dislodge them onto either the trailer floor or onto the loading section 32. The kicker rollers 58 directly contact any objects on the trailer floor and facilitate moving objects on the floor onto the loading section 32. The objects are moved along the collection conveyor system 30 in an object flow direction wherein the loading section 32 moves objects to the collecting section 34, which moves objects to the centering section 36 prior to moving the objects onto the output conveyor 18. The conveyor sections 60, 62, 64, 66 provide movement toward the centering section 36 of the collection conveyor system 30. The perception units 70, 72, 74 may also be employed to provide perception data regarding, for example, the proximity of a stack or pile of objects within the trailer in addition to whether a blockage or jam or slow-down of movement (traffic) of objects exists on any of the conveyor portions 32, 34. Information from the perception units 70, 72, 74 facilitate determining how far to advance the mobile system, whether the objects are near the loading section 32, and where to grasp an object.

With reference again to FIG. 1, when the mobile system 12 is about to enter the trailer 14 of a tractor trailer, the outer wing hinged conveyors portions 40, 42 may be folded upward to facilitate entering the trailer, and the loading portion 32 and collecting portion 34 may be slightly elevated to protect the kicker rollers 58 as the system 12 enters the trailer 14. The mobile system 12 further includes two front drive wheel systems 180 as well as two rear steering wheel systems 182. Although simple castors (passive wheels) could be used in accordance with certain aspects of the invention, the use of active rear steering wheels (e.g., 182) may facilitate maintaining alignment of the object processing system within the trailer. The respective elevations of the loading dock 16 and the floor of the trailer 14 may differ, and a small distance may separate the loading dock 16 and the floor of the trailer 14. If a ramp or temporary threshold is provided bridging the loading dock and the floor, the two front drive wheel systems 180 may still facilitate moving the object processing system onto and over the ramp or temporary threshold.

In accordance with various aspects, the object processing systems disclosed herein may employ a variety of perception systems and perception methodologies. For example, the system may involve engaging a plurality (e.g., three) of perception units 70, 72, 74 (e.g., machine vision smart cameras) mounted above the workspace of the programmable motion devices (shown in FIG. 2). Each of the perception units 70, 72, 74 may capture colorized point cloud data, and each of the perception units is calibrated and positioned at a known location and mutual spacing. The use of two or more such perception units provides unique angles to show three-dimensional natures of the point cloud data. The process may begin by capturing simultaneous point cloud data using the perception units 70, 72, 74. The point cloud data sets are then fused and points outside of the region of interest are removed. The system then removes data associated with noise (radius and statistical outlier removal). As noted above with reference to FIG. 1 and FIG. 2, the system may be both directed toward a pile of objects within the trailer (for approach and collection purposes) as well as toward the loading portion 32 and the collecting portion 34 of the collection conveyor system 30 (for detecting jams or blockages or slow-downs of movement (traffic) of objects on the collection conveyor system 30).

The system will then seek to maximize contact between edges of cups and objects by scoring candidate grasp locations. The system will also seek to prevent grasp locations that are too close together by only including a finite number of grasp locations within voxelized regions of the workspace. In particular, knowing the distance between the perception units, the system will generate a 3D point cloud model and then divide the 3D point cloud model into voxelized regions. The system will then search linearized space, finding the best grasp locations in each voxel. In particular, the system will model each voxel in linearized space and then search over explicit ranges of pitch and roll (with a yaw range set low (e.g., to zero)).

Maintaining the unloading system equidistant between the inner side walls of the trailer may be important not only for efficiently gathering objects, but also for deployment of the outer wing hinged portions 40, 42, as well as to permit access by human personnel (by being rotated upward to permit access). The rear steering wheel systems 182 may guide the mobile system 12 responsive to side perception units 84 (shown in FIG. 1). A rate of movement of the objects in the object flow direction at the collection portion 34 (F collection) may be obtained from perception system 76 that is directed to the collection portion 34 of the conveyor system 30, and a rate of movement of the objects in the object flow direction at the centering portion 36 (F centering) may be obtained from perception system 78 that is directed to the centering portion 36 of the conveyor system 30. In normal operation, the rates F_{collection} and F_{centering} should remain similar. A difference between the rates F_{collection} and F_{centering} above a threshold may trigger the perception systems 70, 72, 74 to provide perception data to the processing system so that the data may be analyzed to look for one or more blockages or jams or slow-down of movement (traffic) of objects. The rate of movement of the mobile system 12 within the trailer 14 may also be adjusted responsive to the flow rate data and any traffic detection data.

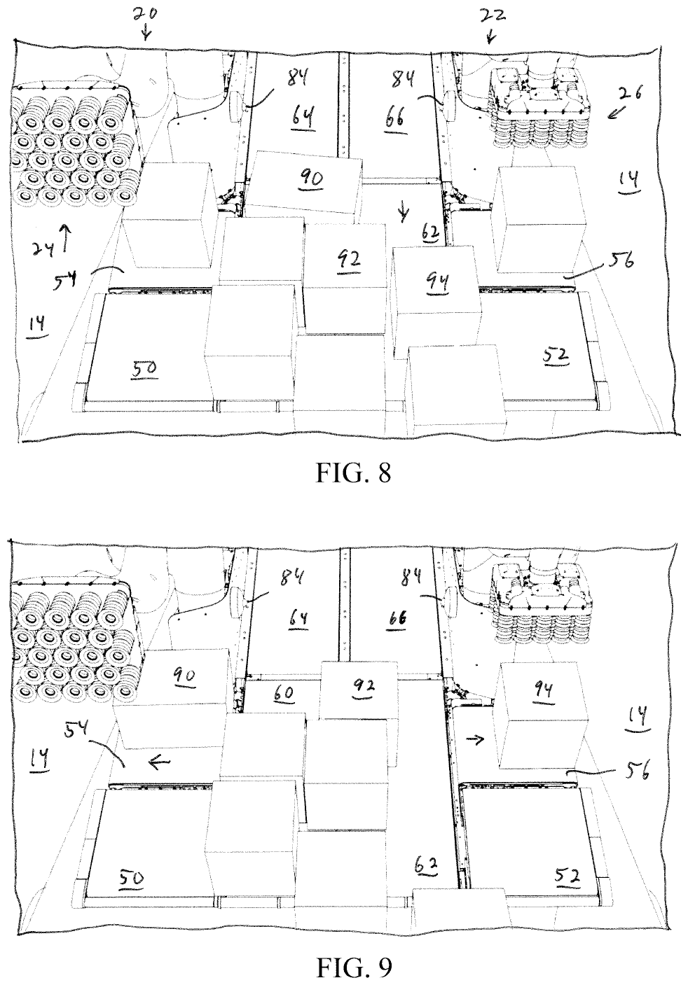

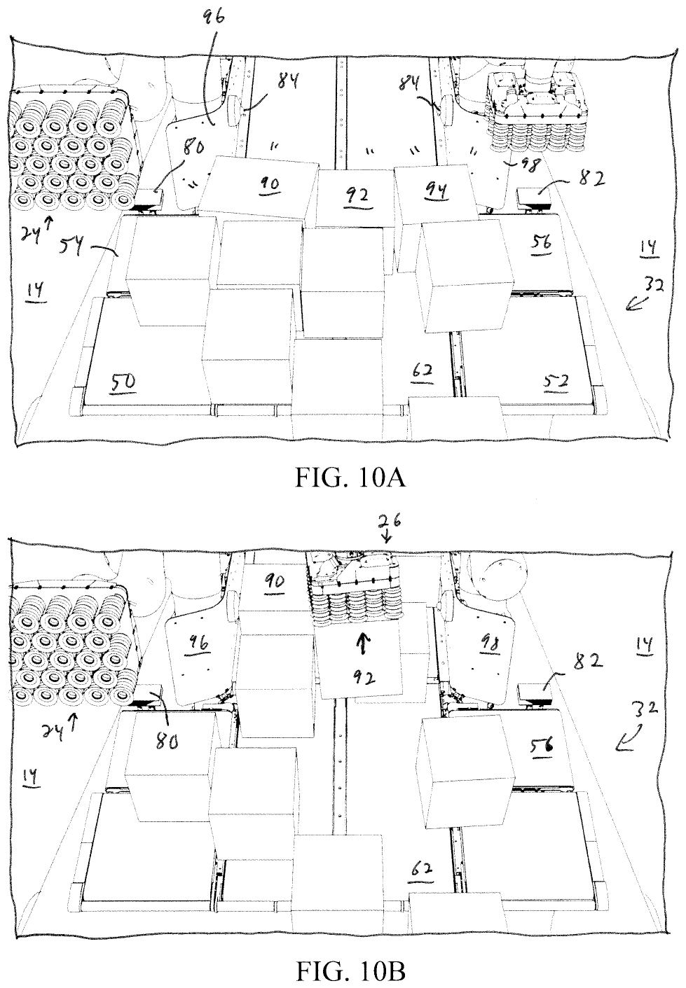

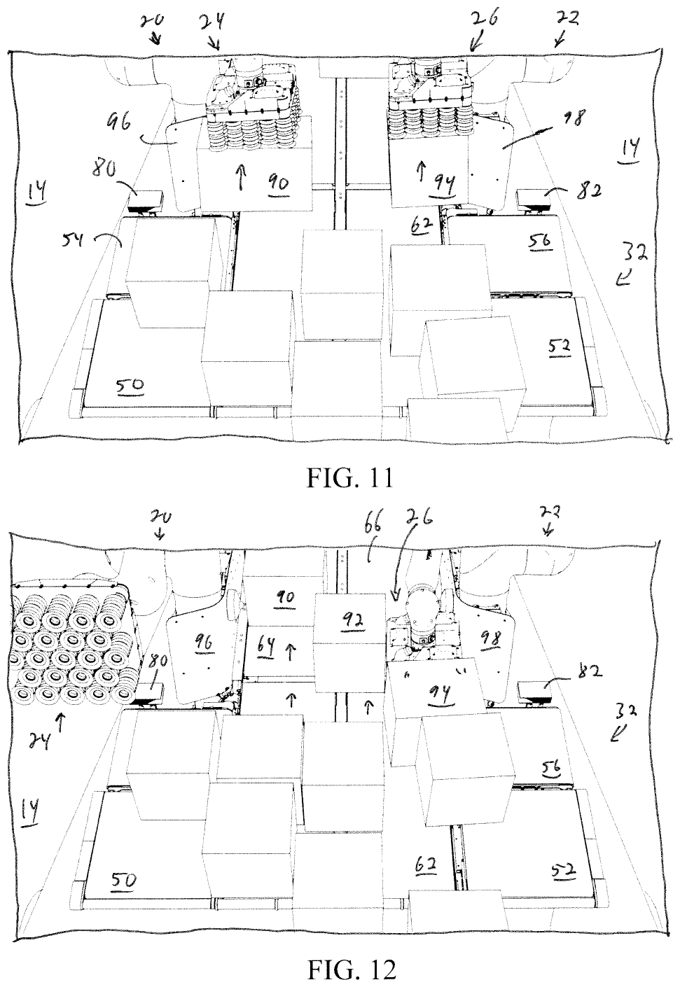

In accordance with further aspects, in certain situations traffic may be cleared by using the conveyor sections either along or in combination with the end-effectors as discussed above with reference to FIG. 10B and FIG. 11. For example, FIG. 7A shows the conveyor sections 60, 62 of the loading section 32 of the conveyor system 30 moving in a reverse direction with respect to the object flow direction. This moves the objects (e.g., 90, 92, 94) in a rearward direction (opposite the object flow direction). FIG. 7B shows that selected conveyor sections only (e.g., 62, 66) may then be engaged in a forward (object flow) direction to dislodge a blockage, for example moving objects 92, 94 in the object flow direction toward the conveyor sections 64, 66. By reversing direction of a single conveyor section certain types of traffic may be easily cleared. The subsequent movement in the object flow direction on selected conveyor sections may then be sufficient to clear the traffic. Similarly, in certain applications the traffic may be cleared by moving a limited number of conveyor sections (e.g., 62) in a reverse direction to differentially dislodge the traffic as shown in FIG. 8 wherein objects 92, 94 are moved in a rearward (opposite the object flow) direction. Where the conveyor sections 60, 62, 64, 66 are each engaged in the object flow direction, the object may freely flow toward to the output conveyor 18.

In accordance with yet further aspects, the collection conveyor system 30 includes conveyor sections 54, 56 that move objects in a cross-object flow direction toward the center of the loading portion 32 of the collection conveyor section. The conveyor sections 54, 56 may also run (concurrently or at different times) in opposite cross-object flow directions away from the center of the loading portion 32, and this may further be used to dislodge a jam. FIG. 9 shows each of conveyor sections 54, 56 having been moved (again either concurrently or at different times) in cross-object flow directions away from the center of the loading portion 32, thus clearing objects 90, 94 from the traffic. As noted above with reference to FIG. 7A-FIG. 9, the movement of the conveyor sections discussed herein may be combined with movement (e.g., blocking, moving or lifting) objects as also described herein.

Additional perception systems such as downward directed perception systems 76 (shown in FIG. 2) and 78 (shown in FIG. 1) may be used to detect any general slow-down of object traffic or general blockage of plural objects as the mobile system 12 is attempting to move them toward the output conveyor 18. In particular, perception system 76 may detect objects that are not moving or moving slowly and identify where they are on the loading section 32 and the collecting portion 34, and perception system 78 may detect that no objects are moving onto the centering portion 36. For example, FIG. 10A shows objects 90, 92, 94 that have become bound up against each other between guides 96, 98, blocking objects from moving up the loading portion to the collecting portion of the collection conveyor system 30. With reference to FIG. 10B, one of the end-effectors (e.g., 26) may be engaged to lift one of the blocking objects (e.g., 92 as shown) permitting the remaining objects to move freely up the loading portion 32 of the collection conveyor system 30. The object 92 may later be placed back on the loading portion 32 when the objects on the loading portion 32 are again moving.

In accordance with further aspects, two end-effectors (e.g., 24, 26) of two programmable motion devices (20, 22) may be employed to each pick up an object (e.g., 90, 94) as shown in FIG. 11. Again, the objects 90, 94 may later be placed back on the loading portion 32 when the objects on the loading section 32 are again moving. The system may employ a number of different approaches to determining when to use one or both programmable motion devices, such as for example, if using one end-effector to lift one object does not clear the conveyor system 30, then both end-effectors are used to lift two objects. The one or more objects may be held until the objects on the loading portion 32 are again moving (as noted above with reference to FIG. 10B) or until the loading portion 32 is empty (e.g., by temporarily ceasing the forward movement of the mobile system 12).

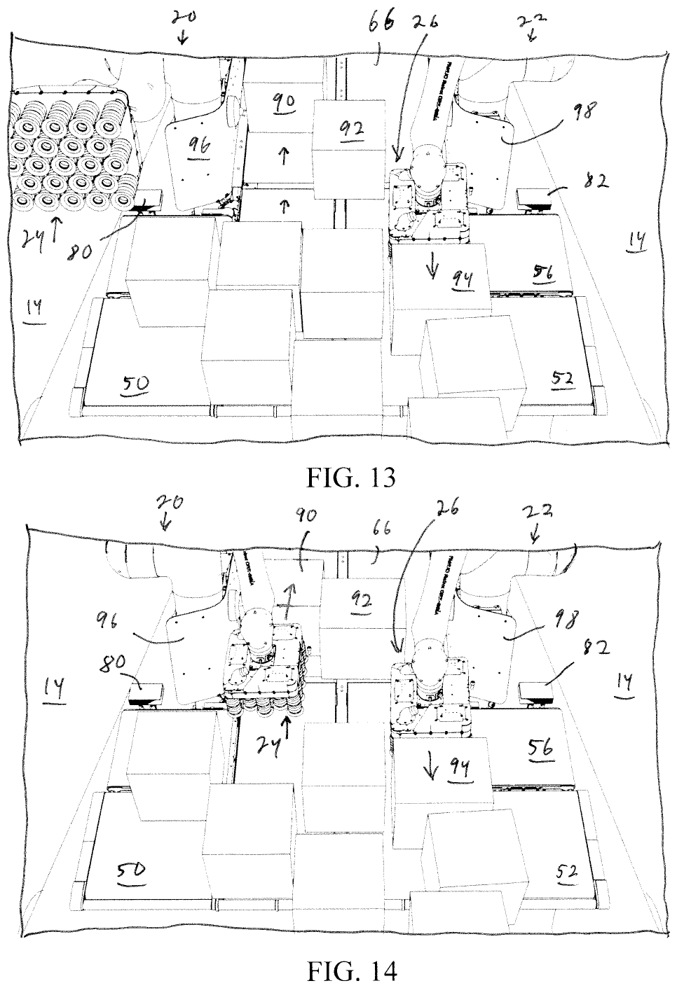

Either or both end-effectors may also be used to stop forward movement of one or more objects to clear a jam, or may be used to move plural objects back down the loading portion 32 of the collection conveyor system 30. For example, FIG. 12 shows the end-effector 26 holding an object 94 from moving forward, permitting other objects 90, 92 to move forward to the conveyor sections 64, 66 of the collection conveyor system 30. Sometimes blocking one or more objects may free up other objects to flow along the conveyor system 30. In accordance with further aspects, the system may also use an end-effector to push an object that is blocking the flow of objects along the conveyor system 30. For example, FIG. 13 shows the end-effector 26 pushing the object 94 rearward with respect to the object flow direction, and FIG. 14 further shows the end-effector 24 pushing the object 90 in a forward direction with respect to the object flow direction. By using the end-effector(s) to push objects, certain types of blockages or jams or slow-down of movement of objects (traffic) may be readily cleared, for example, when the object depth of the traffic is relatively low.

In accordance with further aspects, any or each of the nose rollers 58, any of the conveyor sections 50, 52, 54, 56, 60, 62, 64, 66, 36, 18, and the drive system 182 may include force torque sensors for determining whether any active drive roller is experiencing excessive responsive force on the active drive roller. This information may also be used to detect traffic.

The system may employ different clearance techniques discussed above with reference to FIG. 7A-FIG. 14. For example and with reference to FIGS. 15A and 15B, traffic may be detected (step 1000) using any of the perception systems 80, 82, 84, 86, 87, 88, 70, 72, 74, 76, 78 or force torque sensors as discussed above with reference to FIG. 7A-FIG. 14, and the location of the traffic on the conveyor system may be identified using any of the perception systems (step 1002). Identifying the general location of the traffic may facilitate not only locating objects to be moved, but also may be helpful in identifying the type of clearance action to be employed in clearing the traffic. The system may then identify whether the traffic is caused by a single object or plural objects bound together. A single object may create a blockage if it becomes lodged or held up for any reason unrelated to other objects. Again, identification and determination of this information, the system may better assess the type of clearance action to be employed in clearing the traffic.

In accordance with an aspect of the invention, the system may access recorded data regarding the type of traffic encountered in a learning model system (step 1004). As different types of traffic are encountered, the system will also try different remediation techniques as well as preventive techniques for causing traffic to be avoided. Returning to FIG. 15A, when traffic is encountered, the system may initially engage any of the loading conveyor sections (step 1006) to any of move them in either direction or rapidly move them in alternating directions (jiggle). If the traffic begins to clear the system may end. If not, the system may engage one or both wing conveyor sections (step 1008) by moving them in either direction or rapidly move them in alternating directions (jiggle). Again, if the traffic begins to clear the system may end. If not, the system may engage the collection conveyor sections (step 1010) by moving them in either direction or rapidly move them in alternating directions (jiggle) and/or rotating them upward to engage a side of an object. Again, if the traffic begins to clear the system may end. If not, the system may then engage the centering conveyor section (step 1012) by moving them in either direction or rapidly move them in alternating directions (jiggle) and/or rotating them upward to engage a side of an object. Again, if the traffic begins to clear the system may end.

The system may then engage one programmable motion device (step 1014) to push an object in any direction or lift an object off of the conveyor system 30. If the traffic begins to clear the system may end. If not, the system may then engage one programmable motion device (step 1016) to push plural objects in any direction or lift plural objects off of the conveyor system 30. If the traffic clears, the system may end. If not, the system may engage one or both wing conveyor sections (step 1018) by rotating them upward to engage a side of an object while moving them in either direction or rapidly move them in alternating directions (jiggle). Again, if the traffic begins to clear the system may end. If not, the system may signal for human personnel to intervene (step 1020) and leave the wing conveyor sections elevated for access. Once the system confirms that the traffic is cleared (step 1022) normal operation resumes and the data experienced is recorded (step 1024) adding it to the database for future reference.

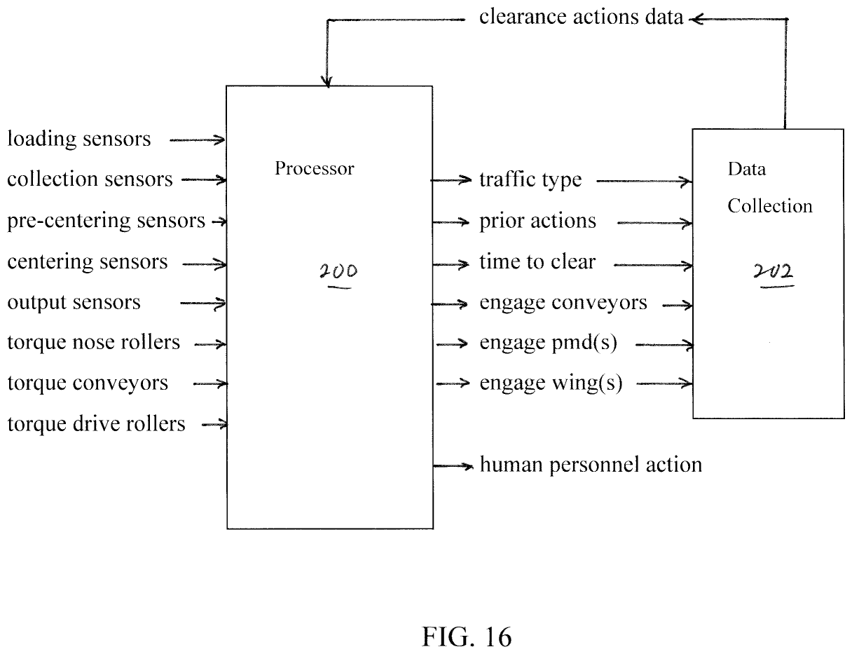

The traffic remediation methodologies discussed herein may be used when the flow of objects is slowed (traffic), but not jammed. By recording different flow conditions and the associated results, significant data may be developed that may aid in avoiding heavy traffic by implementing any of the remediation techniques disclosed herein prior to heavy traffic developing. The learning system discussed below with reference to FIG. 16 may continuously monitor the flow of objects and make small adjustments discussed herein to reduce a likelihood of heavy traffic forming. In this way, jams may be avoided by such traffic flow control.

The above described process may be employed by systems in accordance with various aspects of the invention, and the different object clearing methodologies may be employed in different orders using different criteria in accordance with other aspects of the invention. In accordance with further aspects of the invention, the system may employ machine learning by entering information regarding various parameters of traffic clearance attempts as well as by analyzing and storing data regarding results of the various parameters of traffic clearing attempts. For example, FIG. 16 shows a function diagrammatic view of a machine learning system in accordance with an aspect of the present invention that includes one or more computer processing systems 200 (e.g., 100 shown in FIG. 1) that receive inputs from the loading sensors, the collection sensors, the pre-centering sensors, the centering sensors, the output conveyor sensors, the torque sensors on the nose rollers, the torque sensors on the any of the conveyors, and the torque sensors on the drive rollers.

The one or more computer processing systems 200 analyzes and provides analysis data to a data collection module 202 regarding traffic types, associated prior actions, associated times required to clear traffic, whether conveyors were engaged and which ones and how, whether any programmable motion device was engaged and how, and whether either wing section was raised. The data collection module 202 provides feedback regarding clearance actions data to the one or more computer processing systems 200, and based on all of this learned data and analyses, the system provides recommended clearing action for each and any of a wide variety of traffic types that may occur during trailer unloading.

Those skilled in the art will appreciate that numerous modifications and variations may be made to the above disclosed embodiments without departing from the spirit and scope of the present invention.

1. An object processing system for removing objects from a trailer of a tractor trailer, said object processing system comprising:
a collection conveyance system for moving objects from within the trailer and providing the objects to an output conveyor of the collection conveyor system that leads to an object processing facility;
a perception system for providing perception data regarding at least a portion of the collection conveyance system;
a processing system for identifying whether the collection conveyance system is experiencing traffic with regard to passage of objects along the collection conveyance system; and
a traffic remediation system for determining an action for an end-effector to take to remedy the traffic with regard to passage of objects along the collection conveyance system.

2. The object processing system of claim 1, wherein the collection conveyance system includes a loading section, a collection section and a centering section.

3. The object processing system of claim 2, wherein the loading section includes a leading edge is positioned proximate a floor of the trailer.

4. The object processing system of claim 2, wherein the loading section includes at least four independently movable conveyor sections, at least two of which fold vertically to reduce a width of the object processing system.

5. The object processing system of claim 1, wherein the action for the end-effector includes blocking movement of an object on the collection conveyance system.

6. The object processing system of claim 1, wherein the action for the end-effector includes urging movement of an object on the collection conveyance system in an object flow direction.

7. The object processing system of claim 1, wherein the action for the end-effector includes urging movement of an object on the collection conveyance system in a direction opposite an object flow direction.

8. The object processing system of claim 1, wherein the action for the end-effector includes lifting an object from the collection conveyance system.

9. The object processing system of claim 1, wherein the action for the end-effector includes lifting two objects from the collection conveyance system.

10. An object processing system for removing objects from a trailer of a tractor trailer, said object processing system comprising:
a collection conveyance system for moving objects from within the trailer and providing the objects to an output conveyor that leads to an object processing facility;
a perception system for providing perception data regarding at least a portion of the collection conveyance system;
a processing system for identifying whether movement of objects on the collection conveyance system are slowing with regard to passage of objects along the collection conveyance system; and
a traffic avoidance system for determining an action to take to avoid traffic from developing with regard to passage of objects along the collection conveyance system.

11. The object processing system of claim 10, wherein the action further includes urging movement of an object on the collection conveyance system in an object flow direction.

12. The object processing system of claim 10, wherein the action further includes urging movement of an object on the collection conveyance system in a direction opposite an object flow direction.

13. The object processing system of claim 10, wherein the action further includes lifting an object from the collection conveyance system using an end-effector of a programmable motion device.

14. The object processing system of claim 10, wherein the action further includes lifting two objects from the collection conveyance system using the end-effectors of two programmable motion devices.

15. A method of processing objects comprising:
moving objects from within the trailer of a tractor trailer along a collection conveyance system and providing the objects to an output conveyor that leads to an object processing facility;
providing perception data regarding at least a portion of the collection conveyance system using a perception system;
identifying whether the collection conveyance system is experiencing traffic regarding the passage of objects along the collection conveyance system using a processing system;
determining an action for any of an end-effector or a single conveyor section of the collection conveyor system to take to remedy the traffic regarding the of passage of objects along the collection conveyance system; and
executing the determined action for any of the end-effector or the single conveyor section of the collection conveyor system to take to remedy the traffic regarding the of passage of objects along the collection conveyance system.

16. The method of claim 15, wherein the method further includes accessing stored data regarding prior traffic remediation events in a machine learning system.

17. The method of claim 15, wherein the action for the end-effector includes moving a conveyor section in a jiggling movement.

18. The method of claim 15, wherein the action for the end-effector includes blocking movement of an object on the collection conveyance system.

19. The method of claim 15, wherein the action for the end-effector includes urging movement of an object on the collection conveyance system.

20. The method of claim 15, wherein the action for the end-effector includes lifting an object from the collection conveyance system.
